(19) United States
(12) Patent Application Publication
(10) Pub. No.: US 2010/0042509 A1
(43) Pub. Date: Feb. 18, 2010

(54) METHOD FOR PROVIDING BROADCAST SERVICE TO TERMINAL IN MOBILE BROADCAST SYSTEM AND THE MOBILE BROADCAST SYSTEM THEREFOR

(75) Inventors: Kyung-Shin LEE, Suwon-si (KR); Young-Jip Kim, Suwon-si (KR); Joon-Ho Park, Suwon-si (KR); Ji-Wuck Jung, Suwon-si (KR); Sung-Lyun Jung, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/369,519

(22) Filed: Feb. 11, 2009

(30) Foreign Application Priority Data
Aug. 13, 2008 (KR) 10-2008-0079652

(51) Int. Cl. G06Q 30/00; G06Q 50/00; H04M 3/42

(52) U.S. Cl. 705/26; 455/414.1

(57) ABSTRACT

Disclosed is a method for providing a broadcast service in a mobile broadcast system, and the mobile broadcast system thereof, in which a terminal receiving the broadcast service can check the purchase of the broadcast service, for which the terminal has made a purchase request in a web-based purchase scheme, or can check the purchase cancellation of the broadcast service in a web-based scheme. The mobile broadcast system includes: the terminal for receiving the broadcast service; and a broadcast server for adding a trigger type field to a smartcard trigger message including information on the broadcast service, transmitting the smartcard trigger message to the terminal when the terminal purchases the broadcast service from a content provider in the web-based purchase scheme, and guiding a registration process through a Short Message Service (SMS).

### BACKGROUND OF THE INVENTION

1. Field of the Invention

The present invention relates to a method for providing a broadcast service in a mobile broadcast system and the mobile broadcast system thereof, and more particularly to a method for providing a broadcast service in a mobile broadcast system and the mobile broadcast system thereof, in which a terminal receiving the broadcast service can check the purchase of the broadcast service, for which the terminal has made a purchase request in a web-based purchase scheme, or can check the purchase cancellation of the broadcast service in a web-based scheme.

2. Description of the Related Art

To a mobile communication market, a continuous request is made for producing a new service through the re-combination or integration of existing technologies. Today, with the development of communication and broadcast technologies, a conventional broadcast system or mobile communication system is at the stage of providing a broadcast service through a mobile terminal (hereinafter referred to as “terminal”), such as a mobile phone, a Personal Digital Assistant (PDA), etc. The merger of a mobile communication service and an Internet Protocol (IP) takes its position as the main stream of the development of the next generation mobile communication technology, while combining with potential and actual market demand as described above, users' requirements for a multimedia service, which are rapidly increasing, a strategy of each provider intending to provide a new service, such as a broadcast service, etc. besides an existing voice service, and interests of Information Technology (IT) companies that accept the requirements of demanders and strengthen their mobile communication businesses.

Meanwhile, Open Mobile Alliance (OMA) is an organization which conducts research on standards for interlocking between individual mobile solutions. The OMA mainly plays a role in determining various application standards for games for mobile communication, Internet services, etc. Particularly, an Open Mobile Alliance Browser and Content Mobile Broadcast Sub Working Group (OMA BAC BCAST), which is one of working groups of OMA, is conducting research on a technique for providing a broadcast service by using a terminal. Hereinafter, a mobile broadcast system discussed by the OMA will be briefly described.

The mobile broadcast system includes a process for finding a broadcast service by a terminal capable of receiving a mobile broadcast service, a process for subscribing to the broadcast service by the terminal, a process for providing various control information for receiving the broadcast service, a process for transmitting the broadcast service, and a process for receiving the broadcast service by the terminal.

When a broadcast service desired by a user is charged in the mobile broadcast system as described above, the user who uses the terminal can receive the relevant broadcast service only when the user must complete the purchasing process. Purchase methods include a message-based purchase scheme and a web-based purchase scheme. In the message-based purchase scheme, the terminal transmits a purchase request message to a server, which provides the relevant broadcast service, and the server transmits a response message to the purchase request. By contrast, in the web-based purchase scheme, the user directly connects the terminal to a web server, which provides the relevant broadcast service, and purchases the relevant broadcast service by using the terminal. Servers, which provide mobile broadcast services, include a server which allows only a scheme for purchasing the mobile broadcast service by using a message, a server which supports only a scheme in which the terminal is connected to a web and purchases the mobile broadcast service, and a server which supports both of the two schemes. Also, the user of the terminal may cancel the purchase of the broadcast service through a purchase cancellation process when the user does not desire to use the purchased broadcast service any longer while using it.

In a standard of the current mobile broadcast system, when the web-based purchase is completed, the server transmits a smartcard trigger message to the user, who has requested the broadcast service, and the terminal modifies and stores service information, which the user has purchased, by using information included in the smartcard trigger message.

Meanwhile, whenever executing the broadcast service, the terminal is scheduled to go through a registration process. When the terminal includes the word “ome-bcast-allservice” in a registration request message and transmits the registration message to the server, the server transmits, to the terminal, a response message including list information on all services, which the terminal has purchased. When the registration of the terminal is completed, the server transmits a key, which is necessary to execute a pay broadcast service, in a User Datagram Protocol (UDP) to the terminal.

When a connection between the server and terminal is completed or disconnected due to the occurrence of a problem, the server includes Multimedia Internet KEYing (MIKEY) in a Short Message Service (SMS) message and transmits the SMS message, in order to inform the terminal that the terminal can receive the broadcast service only when the terminal has to go through the registration process again. Table 1 below shows a format of the MIKEY included in the SMS message, and Table 2 below shows a form of the smartcard trigger message.

TABLE 1

Common HDR
EXT MBMS
{EXT BCAST}
TS*
MIKEY RAND
IDi
IDr
{SP}
KEMAC

TABLE 2

| Name | Type | Category | Cardinality | Description | Data Type |
|---|---|---|---|---|---|
| SmartcardProfileTrigger | E | | | Smartcard Profile Trigger | |
| | | | | contains the following | |
| | | | | attributes: | |
| | | | | version, | |
| | | | | keyManagementType and | |
| | | | | permissionsIssuerURI, and | |
| | | | | contains the following sub- | |
| | | | | elements: | |
| | | | | PurchaseItem and | |
| | | | | BackOffTiming | |
| Version | A | NM/TM | 1 | Version of this message. | unsignedByte |
| | | | | 0x00 identifies BCAST | |
| | | | | 1.0 | |
| KeyManagementType | A | NM/TM | 1 | Indicates whether GBA_U | boolean |
| | | | | is required for | |
| | | | | “Registration” message. | |
| | | | | True indicates GBA_U is | |
| | | | | required. | |
| | | | | False indicates GBA_U is | |
| | | | | not required. | |
| PermissionIssuerURI | A | NM/TM | 1 | Identifies URL to which | anyURI |
| | | | | “Registration” message is | |
| | | | | sent. | |
| PurchaseItem | E1 | NM/TM | 1, . . . , N | References set of | |
| | | | | PurchaseItems in Service | |
| | | | | Guide to which terminal | |
| | | | | subscribed over web-based | |
| | | | | interface | |
| | | | | contains the following | |
| | | | | attributes: | |
| | | | | globalIDRef and | |
| | | | | purchaseDataIDRef, and | |
| | | | | contains the following sub- | |
| | | | | elements: | |
| | | | | ProtectionKeyID | |
| GlobalIDRef | A | NM/TM | 1 | Identifies | anyURI |
| | | | | GlobalPurchaseItemID in | |
| | | | | Service Guide to which | |
| | | | | requested service belongs. | |
| | | | | Used by terminal to create | |
| | | | | service ID used in | |
| | | | | “Registration” message. | |
| PurchaseDataIDRef | A | NM/TM | 0, . . . , N | Identifies PurchaseDataID | anyURI |
| | | | | in Service Guide to which | |
| | | | | terminal subscribed. Used | |
| | | | | by terminal to create | |
| | | | | service ID used in | |
| | | | | “Registration” message | |
| ProtectionKeyID | E2 | NM/TM | 0, . . . , N | Optional list of key | base64Binary |
| | | | | identifiers needed to | |
| | | | | access protected content. | |
| | | | | This information allows | |
| | | | | terminal to determine if it | |
| | | | | has correct key material to | |
| | | | | access services within | |
| | | | | PurchaseItem. How this is | |
| | | | | used is out of scope, and is | |
| | | | | left to implementation. | |
| | | | | ProtectionKeyID has | |
| | | | | attribute:- | |
| | | | | type | |
| Type | A | NM/TM | 1 | Type of ProtectionKeyID: | unsignedByte |
| | | | | 0: ProtectionKeyID = | |
| | | | | Key Domain ID | |
| | | | | concatenated with | |
| | | | | SEK/PEK ID, where both | |
| | | | | values are as used in | |
| | | | | Smartcard Profile [BCAST | |
| | | | | 10-ServContProt] | |
| | | | | 1 to 127 reserved for | |
| | | | | future use, and | |
| | | | | 128 to 255 reserved for | |
| | | | | proprietary use. | |
| BackOffTiming | E1 | NM/TM | 0, . . . , 1 | This optional element, | |
| | | | | specifies default timing | |
| | | | | behavior for | |
| | | | | “Registration” message | |
| | | | | sent by terminal. Its | |
| | | | | purpose is to provide | |
| | | | | mechanism which ensures | |
| | | | | distribution over time of | |
| | | | | “Registration” message | |
| | | | | sent by each receiver, e.g. | |
| | | | | in order to avoid overload | |
| | | | | in nodes or links. | |
| | | | | If this element exists, | |
| | | | | “Registration” message | |
| | | | | shall be sent back in time | |
| | | | | interval [OffsetTime, | |
| | | | | OffsetTime + RandomTime] | |
| | | | | after event reception of | |
| | | | | this message. Exact time | |
| | | | | within allowed time | |
| | | | | window shall be random | |
| | | | | with uniform probability. | |
| | | | | If this element does not | |
| | | | | exist, terminal can send | |
| | | | | “Registration” message | |
| | | | | immediately after | |
| | | | | reception of this message. | |
| OffsetTime | A | NM/TM | 1 | OffsetTime specifies | decimal |
| | | | | minimum time that device | |
| | | | | shall wait after reception | |
| | | | | of this message before | |
| | | | | sending “Registration” | |
| | | | | message. Unit is seconds. | |
| RandomTime | A | NM/TM | 1 | RandomTime refers to | decimal |
| | | | | time window length over | |
| | | | | which device shall | |
| | | | | calculate random time for | |
| | | | | transmission of | |
| | | | | “Registration” message. | |
| | | | | The method provides for | |
| | | | | statistically uniform | |
| | | | | distribution over relevant | |
| | | | | period of time. | |
| | | | | Device shall calculate | |
| | | | | uniformly distributed | |
| | | | | random time out of | |
| | | | | interval between 0 and | |
| | | | | RandomTime. Unit is | |
| | | | | seconds | |

However, the conventional format as described above presents only a method in which the user connects the terminal to the web site and purchases the service through the terminal. However, the conventional format does not present a method for cancelling the purchase of the service. Therefore, the method, which can request the web to cancel the purchase of the service, is additionally required. Also, when the user requests the web to cancel the purchase of the service, the server acknowledges the cancellation, but the terminal cannot know if the purchase has been successfully cancelled. Accordingly, a method, which informs the terminal that the purchase of the relevant broadcast service has been successfully cancelled, is additionally demanded.

### SUMMARY OF THE INVENTION

Accordingly, the present invention has been made to solve the above-mentioned problems occurring in the prior art, and the present invention provides a method for providing a broadcast service in a mobile broadcast system and the mobile broadcast system thereof, in which a terminal receiving the broadcast service can check the purchase of the broadcast service, for which the terminal has made a purchase request in a web-based purchase scheme, or can check the purchase cancellation of the broadcast service in a web-based scheme.

In accordance with an aspect of the present invention, there is provided a mobile broadcast system, including: a terminal for receiving a broadcast service; and a broadcast server for adding a trigger type field to a smartcard trigger message including information on the broadcast service and transmitting the smartcard trigger message to the terminal when the terminal purchases the broadcast service through a web server in a web-based purchase scheme.

In accordance with another aspect of the present invention, there is provided a mobile broadcast system, including: a terminal for receiving a broadcast service; and a broadcast server for adding a trigger type field to a smartcard trigger message including information on the broadcast service and transmitting the smartcard trigger message to the terminal when the terminal cancels purchase of the broadcast service in a web-based scheme.

In accordance with still another aspect of the present invention, there is provided a mobile broadcast system, including: a terminal for receiving a broadcast service; and a broadcast server for managing a purchase list including information on all broadcast services including the broadcast service that the terminal has purchased in a web-based purchase scheme, generating a Short Message Service (SMS) message, which requests the terminal to perform a registration process for each of all the broadcast services included in the purchase list such that the terminal can maintain the same purchase list as the broadcast server has, and transmitting the generated SMS message to the terminal.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a block diagram illustrating a schematic configuration of a mobile broadcast system according to an embodiment of the present invention;

FIG. 2 is a flow diagram illustrating a method for providing a broadcast service, which can check the purchase of the broadcast service by a terminal in the mobile broadcast system according to an embodiment of the present invention;

FIG. 3 is a flow diagram illustrating a method for providing a broadcast service, which can check purchase cancellation of the broadcast service by the terminal in the mobile broadcast system according to an embodiment of the present invention;

FIG. 4 is a flow diagram illustrating a method for providing a broadcast service, which can check the purchase of the broadcast service by a terminal in a mobile broadcast system according to another embodiment of the present invention; and

FIG. 5 is a flow diagram illustrating a method for providing a broadcast service, which can check the purchase cancellation of the broadcast service by the terminal in the mobile broadcast system according to another embodiment of the present invention.

### DETAILED DESCRIPTION OF THE EXEMPLARY EMBODIMENTS

Hereinafter, exemplary embodiments of the present invention will be described in detail with reference to the accompanying drawings. It should be noted that, in the accompanying drawings, the same configuration elements will be designated by the same reference numerals throughout the following description and drawings although they may be shown in different drawings. Also, in the following description and accompanying drawings of the present invention, a detailed description of known functions and configurations incorporated herein will be omitted when it may obscure the subject matter of the present invention.

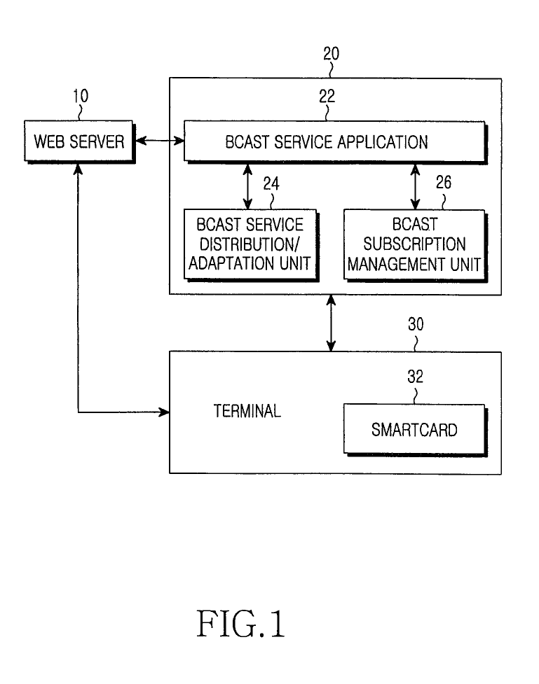

FIG. 1 is a block diagram illustrating a schematic configuration of a mobile broadcast system according to an embodiment of the present invention.

The mobile broadcast system according to an embodiment of the present invention includes a web server 10, a BroadCAST (BCAST) server 20, and a terminal 30.

A user can connect the terminal 30 or a Personal Computer (PC), etc., which is connected to a web, to a web server 10. Also, the web server 10 connects to the BCAST server 20 by user's request, obtains purchase information of the user on a broadcast service managed by the BCAST server 20, and provides the obtained purchase information to the terminal 30 of the user or the PC, etc. Further, the web server 10 provides a service, which can purchase or cancel the purchase of the broadcast service, which is managed by the BCAST server 20, by the user's request.

The BCAST server 20 processes content or a broadcast service, which is received from a content provider, in a form suitable for providing it to the terminal 30, and provides the processed content or broadcast service to the terminal 30. To this end, the BCAST server 20 includes, on the whole, a BCAST Service Application (BSA) 22, a BCAST Service Distribution/Adaptation (BSD/A) unit 24, and a BCAST Subscription Management (BSM) unit 26.

The BSA 22 receives data corresponding to the content or broadcast service from the content provider, and processes the received data in a form suitable for providing media encoding, content protection, a bidirectional service, etc.

The BSD/A unit 24 performs a distribution function and protection function of the broadcast service, as well as a transmission function of each file and streaming, a service collection function, a service protection function, and a generation function and delivery function of a service guide, for the broadcast service.

The BSM unit 26 manages subscriptions to the broadcast service. The BSM unit 26 according to an embodiment of the present invention transmits a smartcard trigger message according to the present invention to the terminal 30. At this time, the BSM unit 26 includes a trigger type, which is a data field for reporting whether the terminal 30 purchases or cancels the purchase of a broadcast service, in the smartcard trigger message.

The terminal 30 receives the content or broadcast service from the BCAST server 20. The terminal 30 includes a smartcard 32. With the smartcard 32, the terminal 30 can receive an encryption key, etc. for receiving the broadcast service from the BCAST server 20, and store and manage the received encryption key, etc. by using the smartcard 32. Also, the terminal 30 receives a smartcard trigger message including a trigger type from the BCAST server 20, so that it can know the purchase or purchase cancellation of the broadcast service in a web-based purchase scheme. The term “web-based purchase scheme” refers to a scheme in which the terminal 30 requests, through the web server 10, the BCAST server 20 to provide various services related to the purchase of a broadcast service. For example, the terminal 30 may connect to the web server 10, and send, to the web server 10, a request for each of purchase, purchase cancellation, purchase details, etc. of the broadcast service. Then, the web server 10 may connect to the BCAST server 20, and by the request of the terminal 30, either purchase the broadcast service to provide the purchased broadcast service to the terminal 30, cancel the purchase of the broadcast service, or obtain the purchase details of the broadcast service to provide obtained purchase details to the terminal 30.

When the terminal 30 purchases the broadcast service, the BSM unit 26 according to an embodiment of the present invention adds the trigger type field to the smartcard trigger message and transmits the smartcard trigger message to the terminal 30 in order to report information on the purchase of the broadcast service. According to an embodiment of the present invention, the broadcast service purchased by the terminal 30 substantially includes not only a broadcast service that the terminal 30 directly connects to the BCAST server 20 and purchases, but also a broadcast service that the user connects, for example, a Personal Computer (PC), etc., not the terminal 30, to the BCAST server 20 and purchases. The broadcast service that the user has purchased through the PC is received by the terminal 30. Accordingly, the terminal 30 can be regarded as a device, which purchases the broadcast service.

By adding the trigger type field to the smartcard trigger message, the BSM unit 26 can inform the terminal 30 that the smartcard trigger message transmitted to the terminal 30 is a message due to the purchase or purchase cancellation of the broadcast service. Even when the user of the terminal 30 connects, for example, the PC, etc., not the terminal 30, to the BCAST server 20 and purchases the broadcast service, the BSM unit 26 according to an embodiment of the present invention transmits the smartcard trigger message, to which the trigger type field is added, to the terminal 30. Accordingly, the BSM unit 26 can also inform the terminal 30 of the purchase of the broadcast service in the web-based purchase scheme, in the same manner as the purchase of the broadcast service that the terminal 30 directly connects to the BCAST server 20 and purchases.

For example, if the trigger type within data included in the smartcard trigger message, which has been transmitted from the BSM unit 26 to the terminal 30, is “SUBSCRIPTION,” the terminal 30 purchases the broadcast service designated in the smartcard trigger message. On the other hand, if the trigger type is “UNSUBSCRIPTION,” the terminal 30 cancels the purchase of the broadcast service. Table 3 below shows a form of the smartcard trigger message according to the present invention.

TABLE 3

| Name | Type | Category | Cardinality | Description | Data Type |
|---|---|---|---|---|---|
| SmartcardProfileTrigger | E | | | Smartcard ProfileTrigger | |
| | | | | contains the following | |
| | | | | attributes: | |
| | | | | version, | |
| | | | | keyManagementType and | |
| | | | | permissionsIssuerURI, and | |
| | | | | contains the following sub- | |
| | | | | elements: | |
| | | | | PurchaseItem and | |
| | | | | BackOffTiming. | |
| version | A | NM/TM | 1 | Version of this message. | unsignedByte |
| | | | | 0x00 identifies BCAST | |
| | | | | 1.0 | |
| keyManagementType | A | NM/TM | 1 | Indicates whether GBA_U | boolean |
| | | | | is required for | |
| | | | | “Registration” message. | |
| | | | | True indicates GBA_U is | |
| | | | | required. | |
| | | | | False indicates GBA_U is | |
| | | | | not required. | |
| permissionIssuerURI | A | NM/TM | 1 | Identifies URL to which | anyURI |
| | | | | “Registration” message is | |
| | | | | sent. | |
| triggerType | A | NM/TM | 1 | Specifies type of | unsignedByte |
| | | | | SmartcardProfileTrigger. | |
| | | | | Allowed values are: | |
| | | | | 0 - SUBSCRIPTION | |
| | | | | TRIGGER, | |
| | | | | 1 - UNSUBSCRIPTION | |
| | | | | TRIGGER, | |
| | | | | 2 to 127 reserved for | |
| | | | | future use, and | |
| | | | | 128 to 255 reserved for | |
| | | | | proprietary use. | |
| PurchaseItem | E1 | NM/TM | 1, . . . , N | References set of | |
| | | | | PurchaseItems in Service | |
| | | | | Guide to which terminal | |
| | | | | subscribed over web-based | |
| | | | | interface | |
| | | | | contains the following | |
| | | | | attributes: | |
| | | | | globalIDRef and | |
| | | | | purchaseDataIDRef, and | |
| | | | | contains the following sub- | |
| | | | | elements: | |
| | | | | ProtectionKeyID. | |
| globalIDRef | A | NM/TM | 1 | Identifies | anyURI |
| | | | | GlobalPurchaseItemID in | |
| | | | | Service Guide to which | |
| | | | | requested service belongs. | |
| | | | | Used by terminal to create | |
| | | | | service ID used in | |
| | | | | “Registration” message. | |
| purchaseDataIDRef | A | NM/TM | 1 | Identifies PurchaseDataID | anyURI |
| | | | | in Service Guide to which | |
| | | | | terminal subscribed. Used | |
| | | | | by terminal to create | |
| | | | | service ID used in | |
| | | | | “Registration” message. | |
| purchaseDataIDRef | A | NM/TM | 1 | Identifies PurchaseDataID | anyURI |
| | | | | in Service Guide to which | |
| | | | | terminal subscribed. Used | |
| | | | | by terminal to create | |
| | | | | service ID used in | |
| | | | | “Registration” message. | |
| ProtectionKeyID | E2 | NM/TM | 0, . . . , 1 | Optional list of key | base64Binary |
| | | | | identifiers needed to | |
| | | | | access protected content. | |
| | | | | This information allows | |
| | | | | terminal to determine if it | |
| | | | | has correct key material to | |
| | | | | access services within | |
| | | | | PurchaseItem. How this is | |
| | | | | used is out of scope and is | |
| | | | | left to implementation. | |
| | | | | If triggerType is 1, this | |
| | | | | element shall not exist. | |
| | | | | ProtectionKeyID has | |
| | | | | attribute:- | |
| | | | | type | |
| type | A | NM/TM | 1 | Type of ProtectionKeyID: | unsignedByte |
| | | | | 0: ProtectionKeyID = | |
| | | | | Key Domain ID | |
| | | | | concatenated with | |
| | | | | SEK/PEK ID, where both | |
| | | | | values are as used in | |
| | | | | Smartcard Profile | |
| | | | | [BCAST 10-ServContProt] | |
| | | | | 1 to 127 reserved for | |
| | | | | future use, and | |
| | | | | 128 to 255 reserved for | |
| | | | | proprietary use. | |
| BackOffTiming | E1 | NM/TM | 0, . . . , 1 | This optional element | |
| | | | | specifies default timing | |
| | | | | behavior for | |
| | | | | “Registration” message | |
| | | | | sent by terminal. Its | |
| | | | | purpose is to provide | |
| | | | | mechanism which ensures | |
| | | | | distribution over time of | |
| | | | | “Registration” message | |
| | | | | sent by each receiver, e.g. | |
| | | | | in order to avoid overload | |
| | | | | in nodes or links. | |
| | | | | If this element exists, | |
| | | | | “Registration” message | |
| | | | | shall be sent back in time | |
| | | | | interval [OffsetTime, | |
| | | | | OffsetTime + RandomTime] | |
| | | | | after event reception of | |
| | | | | this message. Exact time | |
| | | | | within allowed time | |
| | | | | window shall be random | |
| | | | | within uniform probability. | |
| | | | | If this element does not | |
| | | | | exist, terminal can send | |
| | | | | “Registration” message | |
| | | | | immediately after | |
| | | | | reception of this message. | |
| | | | | If triggerType is 1, this | |
| | | | | element shall not exist. | |
| offsetTime | A | NM/TM | 1 | OffsetTime specifies | decimal |
| | | | | minimum time that device | |
| | | | | shall wait after reception | |
| | | | | of this message before | |
| | | | | sending “Registration” | |
| | | | | message. Unit is seconds. | |
| randomTime | A | NM/TM | 1 | RandomTime refers to | |
| | | | | time window length over | |
| | | | | which device shall | |
| | | | | calculate random time for | |
| | | | | transmission of | |
| | | | | “Registration” message. | |
| | | | | The method provides for | |
| | | | | statistically uniform | |
| | | | | distribution over relevant | |
| | | | | period of time. | |
| | | | | Device shall calculate | |
| | | | | uniformly distributed | |
| | | | | random time out of | |
| | | | | interval between 0 and | |
| | | | | RandomTime. Unit is | |
| | | | | seconds. | |

A detailed description of each parameter as shown in Table 3 will be omitted because it is made in Table 4 below.

Meanwhile, whenever executing the broadcast service, or purchasing the broadcast service in the web-based purchase scheme, the terminal 30 goes through the registration process. When the user purchases the broadcast service in the web-based purchase scheme, the BSM unit 26 transmits a Short Message Service (SMS) message, which includes MIKEY, to the terminal 30. The BSM unit 26 can perform the registration process for the broadcast service, through which the terminal 30 goes, by using an EXT MBMS field, which is one of fields included in the MIKEY. Table 4 below shows an EXT MBMS format according to an embodiment of the present invention.

TABLE 4

Key Domain ID sub-payload
Key Type ID sub-payload
(MSK ID)

The EXT MBMS field includes a Key Domain ID and an MSK ID. The MSK ID is again divided into a group part and a number part. When the group part and number part of the MSK ID within the MIKEY are 1 and 0, respectively, the BCAST server must perform a registration process for the terminal 30 such that the terminal 30 can receive a key necessary for receiving a pay broadcast service. At this time, the BSM unit 26 generates an SMS message including the MIKEY, in which the group part and number part of the MSK ID are 1 and 0, respectively, and transmits the generated SMS message to the terminal 30. By transmitting the SMS message, the BSM unit 26 can inform the terminal 30 that the terminal 30 has purchased the broadcast service. When receiving the SMS message from the BSM unit 26, the terminal 30 performs a registration process for each of all broadcast services purchased by the terminal 30. The terminal 30 can recognize that it must newly perform a registration process for a broadcast service that it purchases while performing a registration process. Namely, the terminal 30 can check its purchase of the broadcast service while performing the registration process. At this time, the registration process may refer to, for example, an operation for receiving an encryption key for decoding the received broadcast service when the terminal 30 receives the broadcast service provided by the BCAST server 20.

Also, even when the terminal 30 requests the BCAST server 20 to cancel the purchase of the broadcast service in the web-based purchase scheme, the BCAST server 20 generates an SMS message including the MIKEY, in which the group part and number part of the MSK ID are 1 and 0, respectively, and transmits the generated SMS message to the terminal 30. Accordingly, the terminal 30 performs the registration process for each of all the broadcast services purchased by the terminal 30. Also, the terminal 30 can recognize that broadcast services, for each of which the terminal 30 must perform a registration process, does not include a broadcast service, the purchase of which has been cancelled by the terminal 30 while performing the registration process. Namely, the terminal 30 can check the purchase cancellation of the broadcast service while performing the registration process.

The BSM unit 26 can inform the terminal 30 of the purchase or purchase cancellation of the broadcast service, as described above. At the same time, the BSM unit 26 can easily manage a purchase list, which is a list (e.g. a service name list of broadcast services received by the terminal 30) on all of the broadcast services purchased by the terminal 30. The BSM unit 26 can receive a message, which reports the check of the purchased broadcast service or the purchase cancellation of the broadcast service by the terminal 30, from the web server 10. The BSM unit 26 can generate an SMS message including the MIKEY related to the purchase check or purchase cancellation by the terminal 30, and simultaneously, can update the purchase list related to the relevant terminal 30. Also, the BSM unit 26 transmits, to the terminal 30, the purchase list, which is a list including information on all of the broadcast services purchased by the terminal 30 during the registration process.

The terminal 30 receives content and program support information, such as a service guide, content protection, etc., and provides the broadcast service to the user.

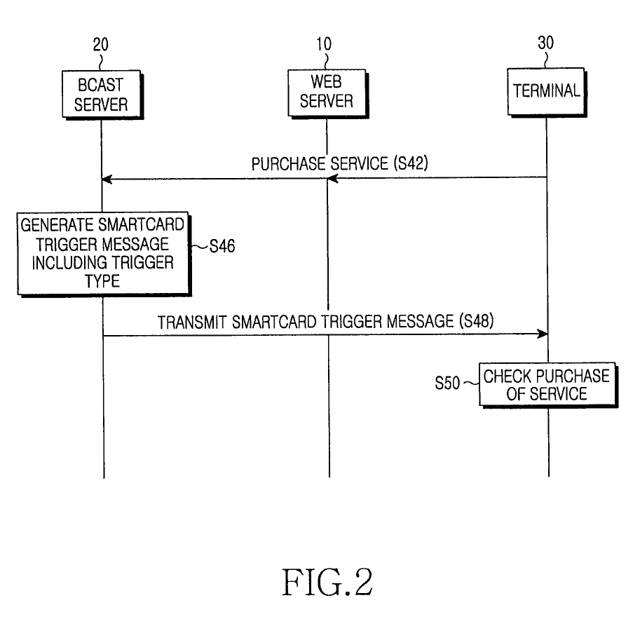

FIG. 2 is a flow diagram illustrating a method for providing a broadcast service, which can check the purchase of the broadcast service by the terminal in the mobile broadcast system according to an embodiment of the present invention.

When the user purchases the broadcast service, which is to be received by the terminal 30 through the BCAST server 20, by using, e.g. the PC, not the terminal 30, in the web-based purchase scheme, the BCAST server 20 purchases the broadcast service provided by the content provider. The BCAST server 20 according to an embodiment of the present invention can receive a user command, which is provided through a connection of the PC, etc. to the BCAST server 20. Then, the BCAST server 20 can purchase the relevant broadcast service according to the received user command. The BCAST server 20 receives the broadcast service, which has been purchased as described above, from the content provider. According to another embodiment of the present invention, the terminal 30 may purchase the broadcast service that the content provider provides through the BCAST server 20 (S42).

The BCAST server 20 generates a smartcard trigger message including a trigger type (S46). By including the trigger type in the smartcard trigger message, the BCAST server 20 can inform the terminal 30 that the terminal 30 has purchased a broadcast service from the content provider in the web-based purchase scheme. Other than this, the BCAST server 20 can inform the terminal 30 if a broadcast service purchased by the terminal 30 has been cancelled in a web-based scheme.

When the BCAST server 20 transmits the smartcard trigger message generated in step S46 (S48), the terminal 30 receives the smartcard trigger message, and checks that it has purchased the broadcast service from the content provider (S50). The terminal 30 according to an embodiment of the present invention displays the purchase of the broadcast service by using, for example, a Liquid Crystal Display (LCD), so that it can inform the user, who uses the terminal 30, of the purchase of the broadcast service. Accordingly, even when purchasing the broadcast service without using the terminal 30 in the web-based scheme, the user can check, through the terminal 30, the broadcast service that the user has purchased in the web-based scheme.

Thereafter, the terminal 30 requests the content provider to provide the broadcast service, through the BCAST server 20. Then, the content provider provides the broadcast service to the terminal 30 through the BCAST server 20. At this time, the BCAST server 20 changes the form of the broadcast service provided by the content provider into a form suitable for the terminal 30.

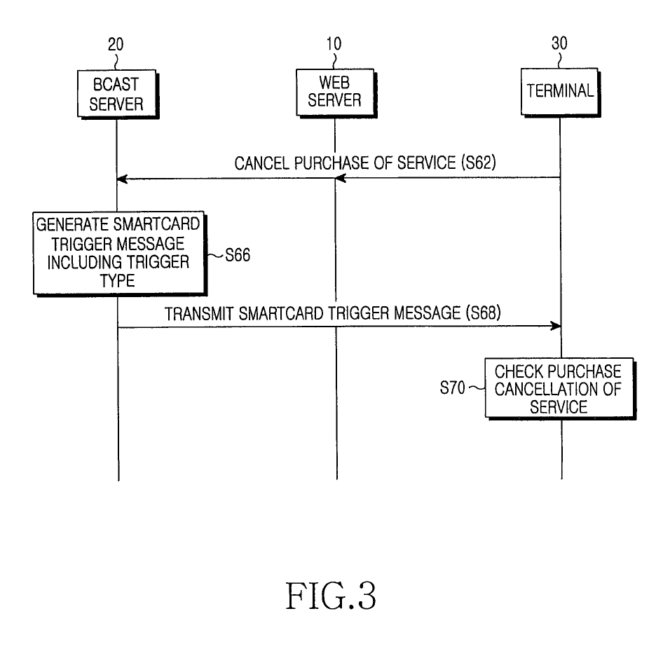

FIG. 3 is a flow diagram illustrating a method for providing a broadcast service, which can check purchase cancellation of the broadcast service by the terminal in the mobile broadcast system according to an embodiment of the present invention.

In an embodiment of the present invention, it is assumed that the terminal 30 is in a state where it has already purchased the broadcast service provided by the content provider. Accordingly, it is assumed that the content provider provides the broadcast service to the terminal 30 through the BCAST server 20.

The user requests, through the web-server 10 by, for example, the PC in the web-based scheme, the BCAST server 20 to cancel the purchase of the broadcast service which is received by the relevant terminal 30. Upon receiving the cancellation request, the BCAST server 20 cancels the purchase of the broadcast service received by the relevant terminal 30 (S62).

The BCAST server 20 generates a smartcard trigger message including a trigger type (S66). At this time, by setting the value of the trigger type to, for example, “UNSUBSCRIPTION,” the BCAST server 20 can inform the terminal 30 that the purchase of the broadcast service has been cancelled. The BCAST server 20 transmits the smartcard trigger message generated in step S66 to the terminal 30 (S68). Then, the terminal 30 checks the purchase cancellation of the broadcast (S70). At this time, the terminal 30 can display the purchase cancellation of the broadcast service to the user by using a display device, such as an LCD, etc.

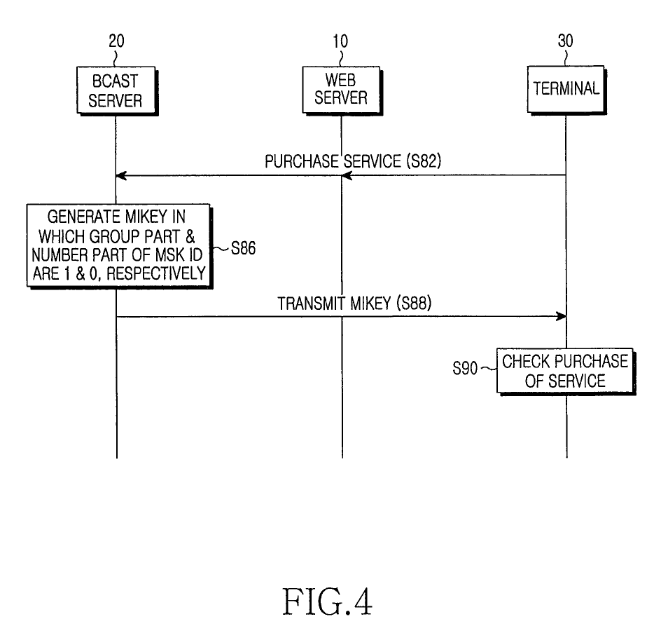

FIG. 4 is a flow diagram illustrating a method for providing a broadcast service, which can check the purchase of the broadcast service by a terminal in a mobile broadcast system according to another embodiment of the present invention.

When the user sends a purchase request to the web server 10 through the terminal 30, the web server 10 transmits purchase request information to the BCAST server 20 (S82). When the broadcast service is successfully purchased, the BCAST server 20 generates an MIKEY, in which the group part and number part of the MSK ID are 1 and 0, respectively (S86). Then, the BCAST server 20 can include the MIKEY generated in step S86 in an SMS message, and can transmit the SMS message to the terminal 30 (S88). The contents of the MIKEY are about guiding a registration process. Therefore, upon receiving the MIKEY, the terminal 30 transmits a registration request message to the BCAST server 20 by using oma-bcast-allservices. Then, the terminal 30 receives a response to the registration request from the BCAST server 20. At this time, the registration request response message includes information on all services purchased by the terminal 30. Therefore, by using the registration request response message, the terminal 30 can maintain the same purchase list information as the BCAST server 20 has.

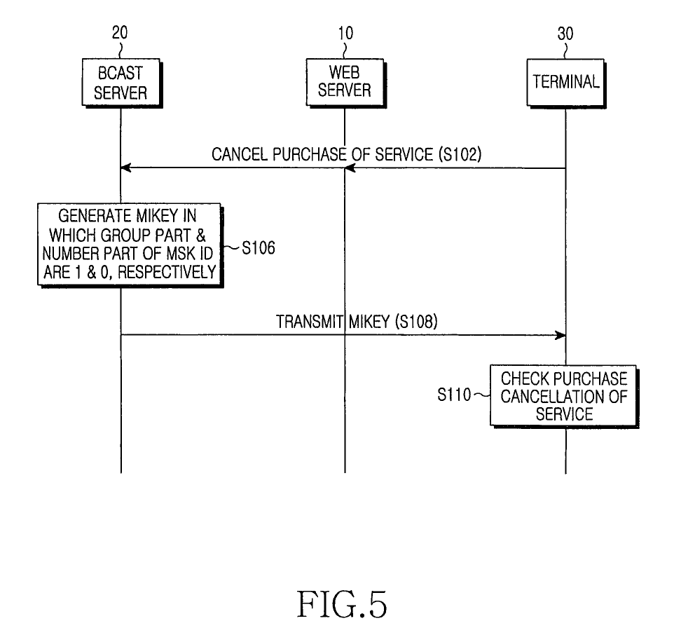

FIG. 5 is a flow diagram illustrating a method for providing a broadcast service, which can check the purchase cancellation of the broadcast service by the terminal in the mobile broadcast system according to another embodiment of the present invention.

In another embodiment of the present invention, it is assumed that the terminal 30 is in a state where it has already purchased the broadcast service. Accordingly, it is assumed that the pay broadcast service is provided to the terminal 30 through the BCAST server 20.

The user requests, through the web-server 10 by, for example, the PC in the web-based scheme, the BCAST server 20 to cancel the purchase of the broadcast service which is received by the relevant terminal 30. Upon receiving the cancellation request, the BCAST server 20 cancels the purchase of the broadcast service received by the relevant terminal 30 (S102).

When the purchase of the broadcast service is cancelled as described above, the BCAST server 20 generates an MIKEY in which the group part and number part of the MSK ID are 1, and 0, respectively (S106). Then, the BCAST server 20 transmits the generated MIKEY to the terminal 30 (S108).

Also, as described above, the BCAST server 20 updates the purchase list related to the terminal 30 (S108), and manages broadcast services received by the terminal 30. According to another embodiment of the present invention, the terminal 30 has cancelled the purchase of the broadcast service. Therefore, the BCAST server 20 removes the information on the relevant broadcast service from the purchase list related to the relevant terminal 30.

When receiving the MIKEY in which the group part and number part are 1 and 0, respectively, the terminal 30 must perform a registration process according to the state of oma-bcast-allservices. The terminal 30 must perform a registration process for each of all the broadcast services registered in the purchase list received from the BCAST server 20. Therefore, the terminal 30 can know that the broadcast service, the purchase cancellation of which has been requested in step S102, is cancelled during the registration process.

When the BCAST server 20 transmits the MIKEY generated in step S106 (S108), as described above, the terminal 30 checks that the purchase of the broadcast service has been cancelled (S110). At this time, the terminal 30 may display the purchase cancellation of the broadcast service by using a display device, such as an LCD, etc.

As described above, the present invention proposes a method for providing a broadcast service in a mobile broadcast system, and the mobile broadcast system thereof, in which a terminal receiving the broadcast service can check the purchase or purchase cancellation of the broadcast service in a web-based scheme.

While the invention has been shown and described with reference to certain exemplary embodiments thereof, it will be understood by those skilled in the art that various changes in form and details may be made therein without departing from the spirit and scope of the invention. Therefore, the spirit and scope of the present invention must be defined not by the described embodiments thereof but by the appended claims and equivalents of the appended claims.

What is claimed is:

1. A mobile broadcast system for providing a broadcast service to a terminal, the mobile broadcast system comprising:
a broadcast server for adding a trigger type field to a smartcard trigger message including information on the broadcast service and transmitting the smartcard trigger message to the terminal when the terminal purchases the broadcast service from a content provider in a web-based purchase scheme.

2. The mobile broadcast system as claimed in claim 1, wherein the terminal receives and analyzes the smartcard trigger message from the broadcast server, and checks the purchase of the broadcast service when a result of the analysis shows that a value of the trigger type field is “SUBSCRIPTION.”

3. A mobile broadcast system for providing a broadcast service to a terminal, the mobile broadcast system comprising:
a broadcast server for adding a trigger type field to a smartcard trigger message including information on the broadcast service and transmitting the smartcard trigger message to the terminal when the terminal cancels purchase of the broadcast service in a web-based scheme.

4. The mobile broadcast system as claimed in claim 3, wherein the terminal receives and analyzes the smartcard trigger message from the broadcast server, and checks the purchase cancellation of the broadcast service when a result of the analysis shows that a value of the trigger type field is “UNSUBSCRIPTION.”

5. A mobile broadcast system for providing a broadcast service to a terminal, the mobile broadcast system comprising:
a broadcast server for managing a purchase list including information on all broadcast services including the broadcast service that the terminal has purchased in a web-based purchase scheme, generating a Short Message Service (SMS) message, which requests the terminal to perform a registration process for each of all the broadcast services included in the purchase list, and transmitting the generated SMS message to the terminal.

6. The mobile broadcast system as claimed in claim 5, wherein the broadcast server sets a value of a group part to zero and a value of a number part to 1 in an MSK IDentifier (ID) of a Multimedia Internet KEYing (MIKEY) included in the SMS message, and generates the SMS message.

7. The mobile broadcast system as claimed in claim 6, wherein, upon receiving the SMS message, the terminal checks the purchase list included in the SMS message, performs the registration process for each of all the broadcast services included in the SMS message, and records only information on each broadcast service, for which the registration process has been performed, in a previously-stored purchase list and manages the stored purchase list including the information.
